(19) United States
(12) Patent Application Publication
(10) Pub. No.: US 2007/0163517 A1
(43) Pub. Date: Jul. 19, 2007

(54) Restraint device for animals

(75) Inventor: Sean McElherron, Cheshire (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: THE CANNY COMPANY LIMITED, Cheshire (GB)

(21) Appl. No.: 10/596,426

(22) PCT Filed: Jan. 13, 2005
(86) PCT No.: PCT/GB05/00088

§ 371 Date: Sep. 6, 2006

(30) Foreign Application Priority Data
Jul. 19, 2004 (GB) 0416096.6
Jan. 14, 2004 (GB) 0400786.0

(51) Int. Cl. A01K 27/00

(52) U.S. Cl. 119/792; 119/795; 119/856

(57) ABSTRACT

A restraint device for an animal which comprises a neck collar for the animal having inter-engagable ends, a surface of the collar having longitudinally spaced apart lead guide means mounted on either side of the longitudinal center of the collar; a lead passing through said lead guide means and having stop means at each end to which a leash is attachable; slider mean mounted on the lead, located between said guide means and arranged to allow a portion of the lead to assume a generally nooselike shape to encompass the nose and mouth regions of the animal, wherein the lead comprises securing means at or towards either end thereof, arranged to be secured or securable together, or to a part of the device, once the leash has been removed from said stop means.

The invention relates to a restraint device for animals and in particular, but not exclusively, to a device for dogs incorporating means for restraining the dog from pulling and, preferably, biting or barking.

Our British patent application published under no. GB 2385506 entitled “A Dog Collar” discloses a restraint which comprises a slip line which extends through four D-rings mounted on a collar. The slip line also extends through a figure-of-eight ring arranged to be located below the dog's muzzle, the slip line being able to encircle the dog's muzzle to thereby provide a ‘controlling’ action, in use.

One potential drawback which has been noted with our above-identified patent application is that when the dog is taken off the lead, it is necessary to remove the restraint because the slip line encircling the dog's muzzle can be ‘pawed off’ and then trails from the neck of the animal, providing a potential choke hazard for the animal and/or a trip-hazard for others or a risk of damage to property.

It is thought that all other similar ‘headcollar’ type training devices and restraints must be removed from the animal once the animal has been taken off the lead. Reference is made to GB 2215973, EP 0199477 and U.S. Pat. No. 4,964,369 which must all be removed subsequent to use, or else provide the potential for damage to property or to the animal through trailing or loose parts.

It is clear that there is a potential benefit in not having to remove the collar each time that an animal is taken off of the lead. This will be particularly felt when there are a large number of animals to be walked, for example, in an animal shelter, although the benefit will also be felt with an individual animal.

U.S. Pat. No. 5,325,819 discloses a dog harness which comprises a neck collar and a lead which extends around the dog's forelegs. The lead is retained on the collar and extends through a guide. The ends of the lead have fasteners which are secured together and to which a leash is secured thereto. When a leash is not secured thereto the fasteners may still be secured together. However this often means that the lead is slack or loose on the animal, thereby providing a ‘snag’ risk for the dog and the potential for damage to property.

Accordingly, it is an object of this invention to provide a restraint which has all the benefits of our earlier patent application but which need not be removed from the animal once the animal has been removed from the lead. It is a non-exclusively further object to provide a restraint which does not comprise materials which will cause a reaction, e.g. a skin reaction, to the restrained animal, and/or in which fur or hair can be caught.

A first aspect of the invention provides a restraint device for an animal, the device comprising a neck collar for the animal having inter-engagable ends, a surface of the collar having longitudinally spaced apart lead guide means mounted on either side of the longitudinal centre of the collar; a lead passing through said lead guide means and having stop means at each end to which a leash is attachable; slider means mounted on the lead, located between said guide means and arranged to allow a portion of the lead to assume a generally noose-like shape to encompass the nose and mouth region of the animal, wherein the lead comprises securing means at or towards either end thereof, arranged to be secured or secureable together or secured or secureable to said guide means once the leash has been removed from said stop means.

Preferably, said guide means are arranged as two outer guide means which are engagable with said stop means and two inner guide means which are located one on each side of the longitudinal centre of the collar, said securing means preferably being secureable to said inner guide means.

Preferably, the lead is longer than the collar, in the range of, for example, from about 2.5 to 1.5 times the length.

Preferably, said securing means comprise sprung clips, say sprung metal or plastics clips. Said securing means may comprise mutually engagable hook-and-eye fasteners. Said securing means may comprise fabric mutually engagable hook-and-eye fixings (e.g. Velcro®) which may be secured (e.g. sewn) to the ends of the lead.

Preferably, said securing means are secured together or to said guide means underneath the animals mouth and nose region, in which case the lead will or is able to encircle the animals neck twice.

Said securing means may be connected, attached or secured to said stop means.

By the term ‘engaged collar’ we mean the length of the collar when the two ends are engaged, e.g. a female clasp engages an eyelet at a male end of the collar appropriate to the animal.

By the term slider means we mean a device which guides and allows relatively free movement of the lead under the nose and mouth region (e.g. the muzzle) of the animal. It is a preferred feature of the invention that the slider means (and any other part likely to contact, e.g. be in extended contact with the skin of the animal during use) the fur or skin of the animal) is made of a material which will not cause an allergic reaction in the animal; the use of certain metals e.g. nickel is preferably avoided. Preferably, the slider is a so called TRIGLIDE (PL 103) which has two sockets and is formed of plastics such as an acetal (polyoxymethylene or polyformaldehyde).

Preferably, the stop means at the ends of the lead define or provide means for engagement with a leash.

A second aspect of the invention provides an animal restraint device comprising a collar arranged to be secured about the animal's neck and lead means retained on the collar and having a portion arranged to encompass the animal's muzzle, in use; said lead means having two ends to which a leash is securable, the ends of said lead means being securable together or to the collar when not secured to a leash.

In order that the invention may be well understood it will now be described by way of example only with reference to the accompanying diagrammatic drawings in which:

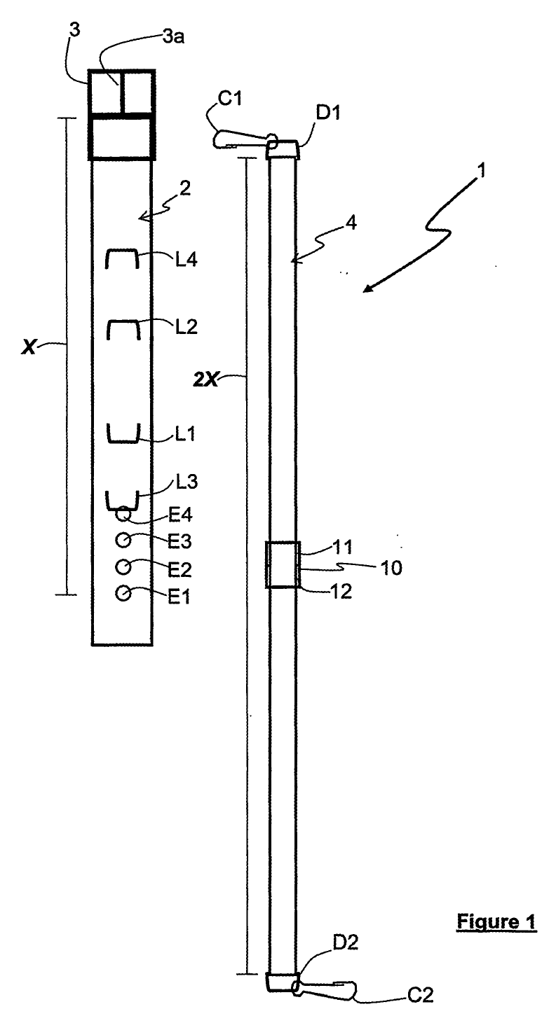

FIG. 1 is a plan view of the parts of a restraint device according to the invention before use;

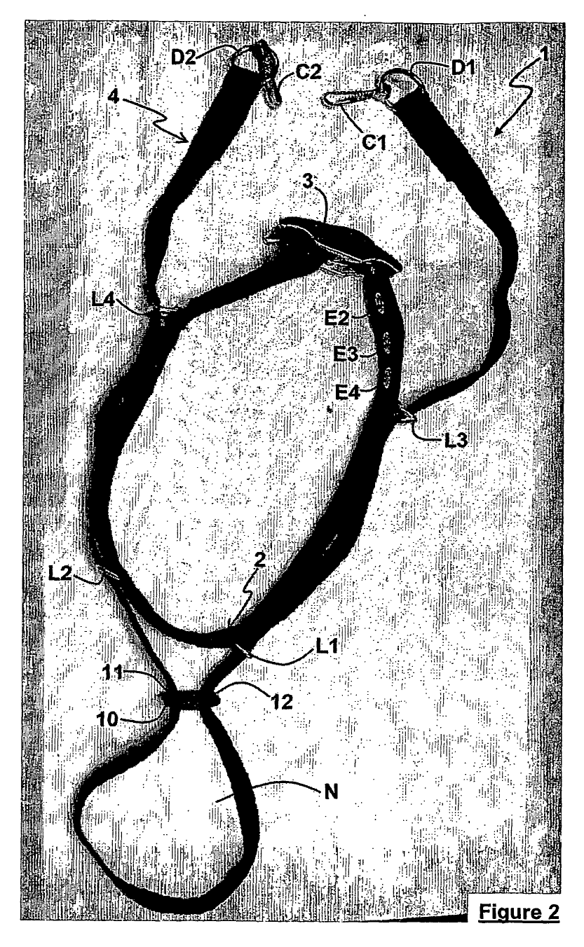

FIG. 2 is a plan view of the restraint device of FIG. 1, showing the parts together, ready for use;

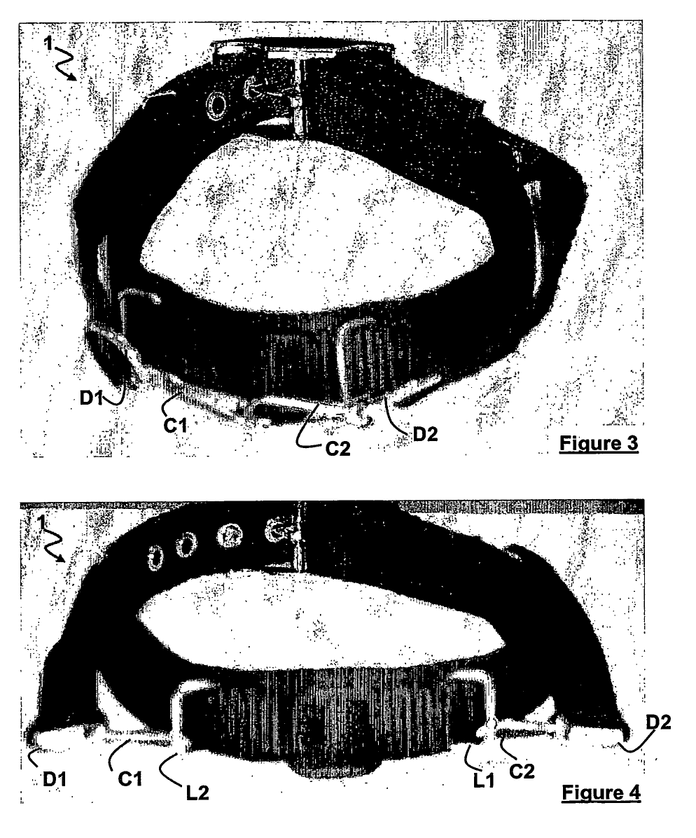

FIG. 3 is a perspective view of the device of FIG. 1 configured for non-restraint use; and

FIG. 4 is a perspective view of the device of FIG. 1 configured for a second embodiment of non-restraint use.

Referring to FIGS. 1 and 2, the device 1 comprises a collar 2 which is a length of strong textile material or webbing or leather having at one end a metal buckle or clasp 3 and at the other, four eyelet protected holes E1 to E4, which can receive the pin 3a of the buckle 3. The collar 2 is intended to be placed about the neck of an animal such as a dog. The eyelets are preferably reinforced by a metal which is not hazardous to the animal e.g. nickel is preferably avoided.

Two pairs of loops are fixed to a surface of the collar 1, e.g. by stitching to act as lead guide means. The inner pair L1, L2 are located about 2.54 cm apart on each side of the longitudinal centre of the collar 2. The outer pair of loops L3, L4 are spaced an equal distance away from the longitudinal centre of the collar 2. The loops act as lead guide means for a lead or strap 4 which, in use, runs through each of the loops L1-L4. The loops L1 to L4 are made of a metal which will not cause an allergic reaction. The lead 4 is narrower than the collar 2 and is also made of strong textile material or webbing.

At each end the lead 4 has a metal D-ring D1, D2 each dimensioned so that it cannot pass through the loop L3, L4 respectively. In this way, the lead 4 is held to the collar 2. The length of the lead 4 is selected so that the distance X between eyelet E1 and the end of the collar 2 at the buckle end of the collar is half the length 2X of the webbing of the lead 4. A slider 10 is present at about the longitudinal midpoint of the strap, that is, in use, between the loops L1, L2. The slider 10 is a figure-of-eight provided with two passages at sockets 11, 12 through which the lead 4 passes. The slider 10 has no sharp parts and is made of plastics such as acetal which has a friction surface; preferably the slider is a TRIGLIDE, preferably a model in the PL 103 range. A sprung metal clip C1, C2 is connected to each D-ring D1, D2 of the lead 4. Each clip C1, C2 is split to provide an occluded opening which is closed by the walls of the clip C1, C2 being resiliently urged into close proximity.

In use, the collar 2 is placed about the neck of a dog and the buckle 3 engaged with an appropriate eyelet-protected hole E1-E4 (the engagement being between the pin 3a and eyelet-protected hole E1 in FIG. 2. The length of lead 4 between the loops L1, L2 is pulled to define a loose noose N and this is placed over the dog's muzzle or nose area to define a restraint which can prevent the dog from opening its mouth to bite or bark. The noose N is tightened by pulling on the ends of the lead 3 but without subjecting the dog to pain. The slider 10 lies beneath the chin of the animal and may contact its fur or skin during use. Because the slider 10 has no sharp parts the fur is not caught or tom. Because it is made of plastics material there is no risk of a skin reaction especially when the dog lowers its head. It will further be appreciated that the slider 10 provides friction surfaces which will not cause the lead to snag, catch or otherwise not run smoothly. A leash (not shown) is clipped to the two D rings, D1, D2. If the dog pulls on the leash, pressure is applied evenly to the muzzle of the dog, via the lead 4, giving control of the animal.

Dogs vary much in size and shape; if a collar 2 is too tight or too loose the device will not work satisfactorily. It is a preferred feature of this invention that the devices are produced in a range of sizes selected so that a good fit will always be available. It is a feature of the invention that each collar is provided with four eyelets E1, E2, E3, E4, and the innermost eyelet E4 of one collar size is the same distance from the buckle 3 as the outermost eyelet E1 of the next collar of shorter length. Such a method of dimensioning the collars ensures that there should always be one which fits a dog.

Referring to FIGS. 3 and 4, there is shown the device 1 of the invention configured as it would be when not in use to walk or restrain the animal. In FIG. 3, the lead 4 is removed from the animal's muzzle and wrapped around the collar 2 so that the lead substantially encompasses the collar 2 twice, the D-rings D1, D2 being brought into close proximity and the clips C1, C2 being connected together. It will be appreciated that the pin 3a of the buckle 3 engages eyelet-protected hole E3. No parts of the device 1 hang from the collar 2, thereby ensuring that an animal to which the device 1 was secured could not choke subsequent to a hanging part becoming caught (or at least reducing the chance of such an incident occurring) or be snagged on an item. In FIG. 4, again the lead 4 substantially encompasses the collar 2 twice but this time the clips C1, C2 are secured to loops L2 and L1 respectively. It will be appreciated that the pin 3a of buckle 3 engages eyelet-protected hole E1 of the collar 2. The lead 4, in this instance is about twice as long as the collar 2.

Of course, if the lead 4 were longer, it could extend further than twice around the collar 2 and it could extend less than twice around the collar 2 if it were substantially shorter. In which cases, the clips C1, C2 could be attached to loops L3 and/or L4.

The clips C1, C2 could be replaced with any suitable securing means. It is preferable that the securing means can attach to itself as well as to the collar 2. Fabric hook-and-eye fasteners (e.g. Velcro®) could be used. In which case the fabric could or would be sewn to the ends of the lead 4, inboard of rings D1 and D2. If it were intended to connect the Velcro® to the collar 2, only one part of the Velcro® need be sewn to each end, for example the hook part as it would adhere to the webbing sufficiently to stay in place. This would also have the advantage that the two ends of the lead 4 would not become secured together during walking or restraint of the animal.

It will be appreciated that once the animal has returned from a walk where it has been humanely restrained using the device 1, it is not necessary to remove the device I from the animal. The leash (not shown) is unclipped from the D-rings D1, D2, the noose N is removed from the animals muzzle and the lead 4 pulled through the loops L1 to L4. The lead 4 is then wrapped around the animal's neck and the clips C1, C2 are secured together or are secured to the loops L1 to L4 (as appropriate), leaving little or none of the lead 4 dangling to provide a choke or snag hazard for the animal or a trip hazard for any other animal or person.

Once the animal is ready to be walked again, the steps are reversed to provide a restraint device 1 which humanely restrains the animal.

The invention has been described in relation to dogs but the device is also applicable to other animals, large or small, domesticated or exotic. The collar and lead may be made in a variety of materials and the methods of holding them together may be varied.

1-16. (canceled)

17. A restraint device for an animal, the device comprising a neck collar for the animal having inter-engagable ends, a surface of the collar having longitudinally spaced apart lead guide means mounted on either side of the longitudinal center of the collar; a lead having a pair of ends, said lead passing through said lead guide means and having stop means at each end to which a leash is attachable; slider means mounted on said lead, located between said lead guide means and arranged to allow a portion of said lead to assume a generally noose-like shape to encompass the nose and mouth region of the animal, wherein said lead comprises securing means at or towards either end thereof, arranged to be secured or securable together, or to a part of said device, once said leash has been removed from said stop means to leave little or none of said lead dangling from said collar.

18. A device according to claim 17, wherein said lead guide means are arranged as two outer guide means which are engagable with said stop means and two inner guide means which are located one on each side of said longitudinal center of said collar.

19. A device according to claim 18, wherein said securing means are securable to said inner guide means.

20. A device according to claim 17, wherein said securing means are securable to one another.

21. A device according to claim 17, wherein said securing means are securable to the collar.

22. A device according to claim 17, wherein said lead is from about 2.5 to 1.5 times longer than said collar.

23. A device according to claim 17, wherein said securing means comprise spring clips.

24. A device according to claim 23, wherein said spring clips comprise metal or plastics clips.

25. A device according to claim 17, wherein said securing means comprise mutually engagable hook-and-eye fasteners.

26. A device according to claim 17, wherein said securing means comprise fabric mutually engagable hook-and-eye fixings, secured to said ends of said lead.

27. A device according to claim 17, wherein said securing means are securable together underneath the animals' mouth and nose region.

28. A device according to claim 17, wherein said slider means is made of a material which does not cause an allergic reaction in the animal to which the device is to be attached.

29. An animal restraint device comprising a collar arranged to be secured about an animal's neck and lead means retained on said collar and having a portion arranged to encompass the animal's muzzle, in use; said lead means having two ends to which a leash is securable, said ends of said lead means being securable together or to said collar when not secured to a leash thereby leaving little or none of said lead means dangling from said collar.

30. A device according to claim 29, comprising slider means through which said lead means extends to form the portion to encompass the animal's muzzle.

31. A device according to claim 30, wherein said slider means comprises a pair of friction surfaces against which said lead means bears and which friction surfaces allow the free, or at least substantially unimpeded, passage of said lead means.

32. An animal restraint device comprising a collar arranged to be secured about an animal's neck and lead means retained on said collar and having a portion arranged to encompass the animal's muzzle, in use; said lead means having two ends to which a leash is securable, said ends of said lead means being securable together or to said collar when not secured to a leash and wherein all parts of the device which, in use, are likely to contact the skin or fur of the animal are formed from material or materials which are not known, or, at least, are considered less likely, to cause allergic reactions to the animal.

33. An animal restraint device comprising a collar arranged to be secured about an animal's neck and lead means retained on said collar and having a portion arranged to encompass the animal's muzzle, in use; said lead means having two ends to which a leash is securable, said ends of said lead means being securable together or to the collar, when not secured to a leash, underneath the animal's muzzle.
